(19) United States
(12) Patent Application Publication
(10) Pub. No.: US 2026/0136240 A1
(43) Pub. Date: May 14, 2026

(54) METHOD AND DEVICE WITH MESSAGE TRANSMISSION REQUEST

(71) Applicant: Samsung Electronics Co., Ltd., Suwon-si (KR)

(72) Inventors: Wonik SEO, Suwon-si (KR); Mincheol KANG, Suwon-si (KR); Seok-Young YOON, Suwon-si (KR)

(73) Assignee: Samsung Electronics Co., Ltd., Suwon-si (KR)

(21) Appl. No.: 19/212,959

(22) Filed: May 20, 2025

(30) Foreign Application Priority Data
Nov. 13, 2024 (KR) 10-2024-0161417

(51) Int. Cl. H04W 28/12; H04W 4/20

(52) U.S. Cl. CPC H04W 28/12; H04W 4/20

(57) ABSTRACT

An electronic device includes one or more processors configured to determine whether to activate a message split circuitry included in a network interface card (NIC) based on either one or both of information on one or more running applications and an estimated latency, and store the determination of whether to activate the message split circuitry in a split register included in the NIC, and the NIC configured to obtain a message transmission request for transmitting one or more portions of a target message to a destination based on the one or more running applications, split, using the message split circuitry of the NIC, the one or more portions of the target message into two or more packets using the message split circuitry and transmit the two or more packets to the destination in response to a value indicating activation of the message split circuitry being stored in the split register, and transmit the one or more portions of the target message, as a single packet, to the destination in response to a value indicating deactivation of the message split circuitry being stored in the split register.

### CROSS-REFERENCE TO RELATED APPLICATIONS

This application claims the benefit under 35 USC § 119(a) of Korean Patent Application No. 10-2024-0161417, filed on Nov. 13, 2024 in the Korean Intellectual Property Office, the entire disclosure of which is incorporated herein by reference for all purposes.

### BACKGROUND

1. Field

The following description relates to a method and device with message transmission.

### 2. Description of Related Art

In modern network systems, a remote direct memory access (RDMA) technology may support direct data transmission between memory areas of different systems without intervening an operating system (OS) each time. A key component for the RDMA may include an RDMA network interface card (RNIC). RNICs support high-speed and low-latency communications, and may have great advantages in minimizing latency and central processing unit (CPU) load, particularly in environments that require large-scale data processing, such as cloud data centers or high-performance computing (HPC) environments.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, an electronic device includes one or more processors configured to determine whether to activate a message split circuitry included in a network interface card (NIC) based on either one or both of information on one or more running applications and an estimated latency, and store the determination of whether to activate the message split circuitry in a split register included in the NIC, and the NIC configured to obtain a message transmission request for transmitting one or more portions of a target message to a destination based on the one or more running applications, split, using the message split circuitry of the NIC, the one or more portions of the target message into two or more packets using the message split circuitry and transmit the two or more packets to the destination in response to a value indicating activation of the message split circuitry being stored in the split register, and transmit the one or more portions of the target message, as a single packet, to the destination in response to a value indicating deactivation of the message split circuitry being stored in the split register.

The NIC may include a remote direct memory access (RDMA) NIC (RNIC) supporting an RDMA, and the NIC may be configured to receive the message transmission request independently of an operating system (OS).

Theone or more processors may be configured to determine deactivation of the message split circuitry in response to a latency-sensitive type application not being present among the one or more running applications.

The electronic device may include a switch comprising a congestion status register configured to store a congestion status of a network, and the one or more processors may be configured to determine whether to activate the message split circuitry based on the congestion status and the estimated latency, in response to a latency-sensitive type application being present and another type of application different from the latency-sensitive type application not being present among the one or more running applications.

The other type may include either one or both of a bandwidth-sensitive type and a throughput-sensitive type.

The one or more processors may be configured to determine the deactivation of the message split circuitry in response to the congestion status being greater than or equal to a threshold level and the estimated latency being greater than or equal to a target latency, and determine the activation of the message split circuitry in response to either one or both of the congestion status being less than the threshold level and the estimated latency being less than the target latency.

The one or more processors may be configured to determine the activation of the message split circuitry in response to a latency-sensitive type application and another type of application different from the latency-sensitive type application being present among the one or more running applications.

The one or more processors may be configured to, in response to a latency-sensitive type application and another type of application being present among the one or more running applications, determine the deactivation of the message split circuitry in response to the estimated latency being greater than or equal to a target latency and a transmission rate for the other type of application being greater than or equal to a threshold rate, and, in response to the latency-sensitive type application and the other type of application being present among the one or more running applications, determine the activation of the message split circuitry in response to the estimated latency being less than the target latency and the transmission rate for the other type of application being less than the threshold rate.

The one or more processors may be configured to determine the estimated latency by transmitting a probing message to a destination of one or more message transmission requests from the one or more running applications.

The one or more processors may be configured to determine the estimated latency by periodically transmitting the probing message with a size less than or equal to a threshold message size to the destination.

The electronic device may include a memory comprising an intermediate queue, and the one or more processors may be configured to transmit the message transmission request to the NIC in response to the message transmission request being generated based on a latency-sensitive type application among the one or more running applications, insert the message transmission request to the intermediate queue in response to the message transmission request being generated based on another type of application different from the latency-sensitive type application among the one or more running applications, and transmit one or more portions of the message transmission request inserted to the intermediate queue to the NIC in response to determining to extract an element from the intermediate queue.

The one or more processors may be configured to compare a size of the target message with a threshold message size in response to the message transmission request being generated regarding the other type of application among the one or more running applications, divide the message transmission request into partial message transmission requests and insert the partial message transmission requests, as a plurality of elements, into the intermediate queue in response to the size of the target message being greater than or equal to the threshold message size, and insert the message transmission request to the intermediate queue in response to the size of the target message being less than or equal to the threshold message size, and the NIC may be configured to transmit a partial message indicated by the partial message transmission request as either one of a single packet or two or more packets in response to the partial message transmission request being received through the intermediate queue.

The one or more processors may be configured to determine to extract the element from the intermediate queue based on a transmission rate for the other type of application.

The one or more processors may be configured to, in response to the estimated latency being greater than or equal to a target latency, reduce the transmission rate for the other type of application based on a half of the transmission rate, and, in response to the estimated latency being less than the target latency, increase the transmission rate.

The electronic device may include a congestion status register configured to store a congestion status of a network, and the one or more processors may be configured to, in response to the transmission rate being reduced, reduce a size of a partial message indicated by each partial message transmission request in response to the reduced transmission rate being less than a threshold rate and the congestion status being less than a threshold level.

The one or more processors may be configured to, in response to the transmission rate being reduced, adjust the reduced transmission rate to a smaller value in response to the reduced transmission rate being less than the threshold rate and the congestion status being the threshold level or more.

The one or more processors may be configured to determine a time interval based on the transmission rate and a size of a partial message, and determine to extract the element from the intermediate queue at the determined time interval.

In one or more general aspects, a method includes determining, by one or more processors, whether to activate a message split circuitry included in a network interface card (NIC) based on either one or both of information on one or more running applications and an estimated latency, storing, by the one or more processors, the determination of whether to activate the message split circuitry in a split register included in the NIC, obtaining, by the NIC, a message transmission request for transmitting one or more portions of a target message to a destination based on the one or more running applications, splitting, by the message split circuitry of the NIC, the one or more portions of the target message into two or more packets using the message split circuitry and transmitting the two or more packets to the destination in response to a value indicating activation of the message split circuitry being stored in the split register, and transmitting, by the NIC, the one or more portions of the target message, as a single packet, to the destination in response to a value indicating deactivation of the message split circuitry being stored in the split register.

The NIC may include a remote direct memory access (RDMA) NIC (RNIC) supporting an RDMA, and the NIC may be configured to receive the message transmission request independently of an operating system (OS).

In one or more general aspects, a non-transitory computer-readable storage medium may store code that, when executed by the one or more processors, configures the one or more processors to perform the determining of whether to activate the message split circuitry, and the storing of the determination of whether to activate the message split circuitry in the split register.

Other features and aspects will be apparent from the following detailed description, the drawings, and the claims.

### BRIEF DESCRIPTION OF THE DRAWINGS

FIG. 1 illustrates an example of a configuration of an electronic device.

FIG. 2 illustrates an example of a method transmitting at least a portion of a target message to a destination based on a message transmission request by an electronic device.

FIG. 3 illustrates an example of an operation of determining activation of message split circuitry by an electronic device.

FIG. 4 illustrates an example of an operation of transmitting a message transmission request to a network interface card based on a type of an application by an electronic device.

FIG. 5 illustrates an example of an operation of determining a transmission rate by an electronic device.

FIG. 6 illustrates an example of an operation of a directing module.

Throughout the drawings and the detailed description, unless otherwise described or provided, the same drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms such as “first,” “second,” and “third,” or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but is used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on,” “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” to specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, should be construed to have meanings matching with contextual meanings in the relevant art and the disclosure of the present application, and are not to be construed to have an ideal or excessively formal meaning unless otherwise defined herein. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment,” and “one or more examples” has a same meaning as “in one or more embodiments”).

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Hereinafter, examples will be described in detail with reference to the accompanying drawings. When describing the examples with reference to the accompanying drawings, like reference numerals refer to like elements and a repeated description related thereto will be omitted.

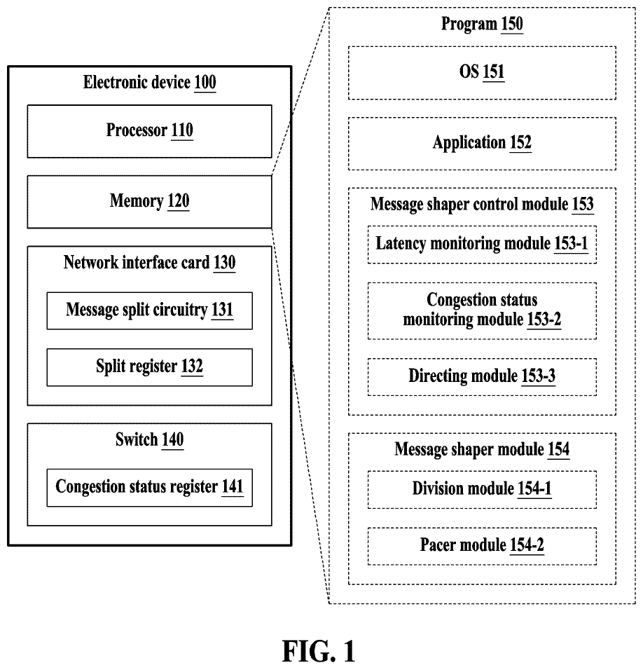

FIG. 1 illustrates an example of a configuration of an electronic device.

An electronic device 100 may include a processor 110 (e.g., one or more processors), a memory 120 (e.g., one or more memories), a network interface card (NIC) 130, and a switch 140.

The processor 110 may perform various computational tasks and control operations of the electronic device 100. The processor 110 may include at least one processor 110. Each processor 110 may include a processing circuit. The processor 110 may transmit and receive data to and from other components (e.g., the memory 120 and/or the NIC 130) of the electronic device 100.

The memory 120 may store data, and support a function that the processor 110 and the NIC 130 quickly access the memory 120. The memory 120 may include one or more storage media for storing instructions. For example, the memory 120 may be or include a non-transitory computer-readable storage medium storing code that, when executed by the processor 110, configures the processor 110 to perform any one, any combination, or all of operations and/or methods of the processor 110. At least a portion of a memory area of the memory 120 may be allocated for an application 152 based on the application 152 running. The memory area allocated for the application 152 may include data and/or a temporary storage space for the running application 152.

The memory 120 may be included in the electronic device 100 as a hardware component and store a program 150. The program 150 may include an operating system (OS) 151 and an application 152.

The OS 151 may manage hardware resources of the electronic device 100, and support for the application 152 to operate smoothly. The OS 151 may control basic operations of the electronic device 100 through memory management, input/output control, processor scheduling, and the like. The OS 151 may process a request (e.g., a message transmission request) from the application 152.

The application 152 may cause the processor 110 to perform a specific function or a specific task. The memory 120 may store instructions and data for executing the application 152, and manage related data to be transmitted to the processor 110 when the application 152 is executed.

As will be described in examples later, the message transmission request may be generated regarding the application 152 (and/or based on the application 152). The message transmission request may request transmission of a message stored in the memory 120 to a destination. The message transmission request may include at least one of information about an area of the memory 120 where the message is stored (e.g., a memory address), information about a destination (e.g., an Internet Protocol (IP) address and/or Media Access Control (MAC) address of the destination), and/or information about a message (e.g., a size of a message or priority). The message transmission request generated based on the application 152 may include a message transmission request generated as a result of execution while the processor 110 executes at least some of the instructions of the application 152. In various examples of the present disclosure, the generation of the message transmission request based on the application 152 may also be expressed as the application 152 generating the message transmission request.

The NIC 130 (e.g., a network interface controller, a network adapter, a LAN adapter, and/or a physical network interface) may refer to a hardware device that supports physical connection and/or logical connection with a network and transmits and receives data through a network. The NIC 130 may receive the message transmission request. The NIC 130 may obtain a message based on the message transmission request and transmit the message to the network through one or more packets. As will be described in examples later, the NIC 130 may transmit the one or more packets to the switch 140. A packet may refer to a transmission unit that is transmitted when transmitting data via a network.

According to an example, the NIC 130 may further include message split circuitry 131 and a split register 132. The message split circuitry 131 may split a message into one or more packets. The split register 132 may store whether the message split circuitry 131 is activated. For example, the split register 132 may store one of a first value indicating activation of the message split circuitry 131 or a second value indicating deactivation of the message split circuitry 131. When the first value indicating the activation of the message split circuitry 131 is stored in the split register 132, the message split circuitry 131 may split the message into two or more packets and the message may be processed (e.g., output) as two or more packets. When the second value indicating the deactivation of the message split circuitry 131 is stored in the split register 132, the message may be processed (e.g., output) as a single packet independently of the message split circuitry 131 (e.g., by bypassing the message split circuitry 131). As will be described in examples later, a value stored in the split register 132 may be determined by a module (e.g., a message shaper control module 153).

The NIC 130 may process data through a network stack of the OS 151. For example, the NIC 130 may support a Transmission Control Protocol (TCP)/IP network protocol and secure reliable data communication between devices.

According to an example, the NIC 130 may include a remote direct memory access (RDMA) NIC (RNIC). The RNIC may support RDMA. The RDMA may refer to a function of the application 152 running by the electronic device 100 transmitting the message transmission request directly to the NIC 130 without going through (e.g., without using) an OS 151. The NIC 130 may receive the message transmission request independently of the OS 151. Through the RDMA, the message transmission based on the application 152 may be performed more quickly. For example, through the RDMA, the NIC 130 of one or more embodiments may reduce latency that occurs when passing through the OS 151 during the message transmission based on the application 152 and/or may improve network performance.

The message transmission request based on the application 152 may be transmitted to the NIC 130. The message transmission request based on the application 152 may be processed in one of a general mode or an RDMA mode. The message transmission request based on the application 152 may be transmitted to the NIC 130 based on the OS 151 when the message transmission request is processed in the normal mode. When the message transmission request based on the application 152 is processed in the RDMA mode, the message transmission request may be transmitted to the NIC 130 independently of the OS 151.

When the message transmission request based on the application 152 is processed in the RDMA mode, the program 150 may include software module(s) for supporting an operation of transmitting to the NIC 130. The program 150 may include the message shaper control module 153 and a message shaper module 154.

For reference, a software module may include instructions and may be stored in the memory 120. The instructions, when executed by the processor 110, may cause the electronic device 100 to perform an operation instructed by the instructions. Accordingly, in examples herein, one of the modules 153, 153-1, 153-3, 154, 154-1, and 154-2 performing an operation may mean that the processor 110 (and/or another hardware component of the electronic device 100) performs the operation when instructions included in the one module are executed by the processor 110.

The message shaper control module 153 may control (e.g., when instructions included in the message shaper control module 153 are executed by the processor 110, the processor 110 may control) at least a portion of an operation of the NIC 130 and/or an operation of the message shaper module 154. The message shaper module 154 may divide a message based on the message transmission request into a plurality of partial message transmission requests for a plurality of partial messages. The message shaper module 154 may transmit the message transmission request or the partial message transmission request to the NIC 130.

The message shaper control module 153 may include a latency monitoring module 153-1, a congestion status monitoring module 153-2, and a directing module 153-3.

The latency monitoring module 153-1 may determine an estimated latency by transmitting a probing message to a destination of at least one message transmission request from the running application 152. The latency monitoring module 153-1 may determine the estimated latency by periodically transmitting the probing message having a threshold message size or less (e.g., having a size less than or equal to the threshold message size) to the destination. For example, the latency monitoring module 153-1 may determine the estimated latency of the 99^{th} percentile among the probing messages.

The congestion status monitoring module 153-2 may determine a congestion status of a network. For example, the electronic device 100 may include the switch 140 that includes a congestion status register 141 that stores the congestion status of the network. The congestion status monitoring module 153-2 may store a value indicating a congestion status (e.g., in the memory 120 and/or the congestion status register 141). The congestion status may include a congestion status of an egress port included in the switch 140. The congestion status of the egress port may indicate the amount of data in an output buffer corresponding to the egress port. The congestion status monitoring module 153-2 may determine the congestion status of the network and/or the congestion status of the egress port of the switch 140 based on a value indicating the congestion status obtained as a result of accessing the congestion status register 141.

The directing module 153-3 may determine whether to activate the message split circuitry 131 of the NIC 130. For example, the directing module 153-3 may determine whether to activate the message split circuitry 131 based on at least one of information about the running application 152 and/or the estimated latency (e.g., the estimated latency determined by the latency monitoring module 153-1). The directing module 153-3 may store the determination of whether to activate the message split circuitry 131 (or a value indicated whether to activate) in the split register 132.

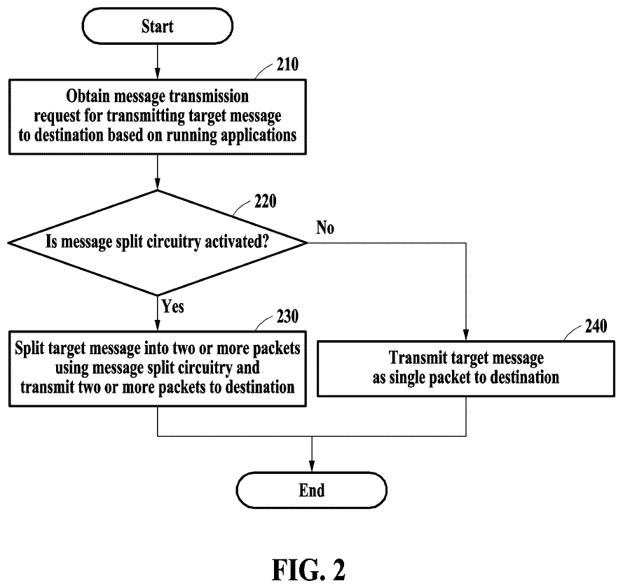

The directing module 153-3 may control an operation of dividing the message transmission request of the message shaper module 154 into a plurality of partial message transmission requests and/or an operation of transmitting the message transmission request (or the partial message transmission request) to the NIC 130. For example, the directing module 153-3 may determine at least one of a size of a partial message and/or a transmission rate of each partial message transmission request of the message shaper module 154. The partial message may refer to a portion of a message indicated by the partial message transmission request. The transmission rate may refer to a speed at which the message transmission request (or the partial message transmission request) stored in an intermediate queue is transmitted to the NIC 130. The transmission rate may, for example, represent a size (unit: bytes) of a message (or a partial message) of a message transmission request (or a partial message transmission request) transmitted per unit time. Examples of the operation of the directing module 153-3 will be described in more detail later with reference to FIGS. 2 to 5.

According to an example, the message shaper module 154 may include a division module 154-1 and a pacer module 154-2.

The division module 154-1 may divide the message transmission request into the plurality of partial message transmission requests. The division module 154-1 may inset the plurality of partial message transmission requests into an intermediate queue (not shown). The intermediate queue may be a hardware module accessible through the message shaper control module 153, and may store the message transmission request or the partial message transmission request as an element.

The pacer module 154-2 may transmit the message transmission request or the partial message transmission request from the intermediate queue to the NIC 130. The pacer module 154-2 may extract elements from the intermediate queue and/or transmit the elements to the NIC 130 based on the transmission rate determined by the directing module 153-3.

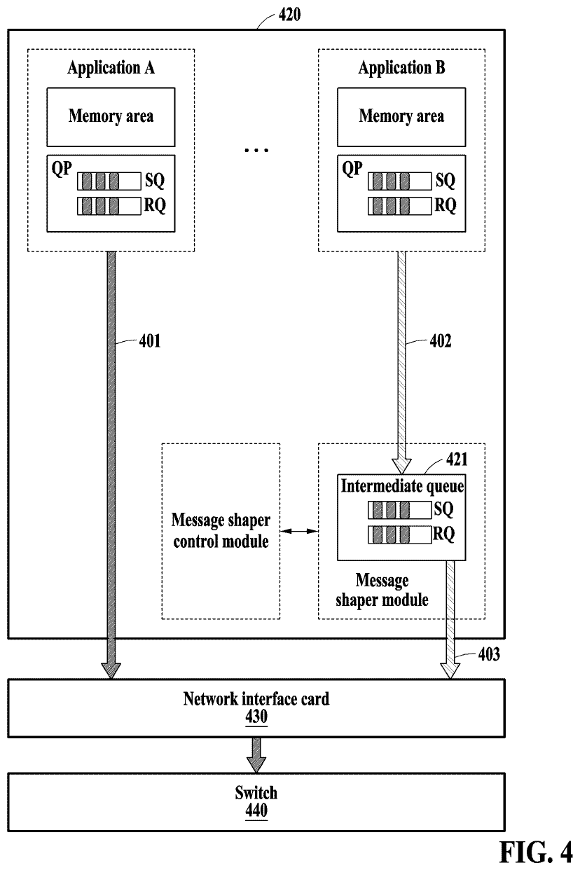

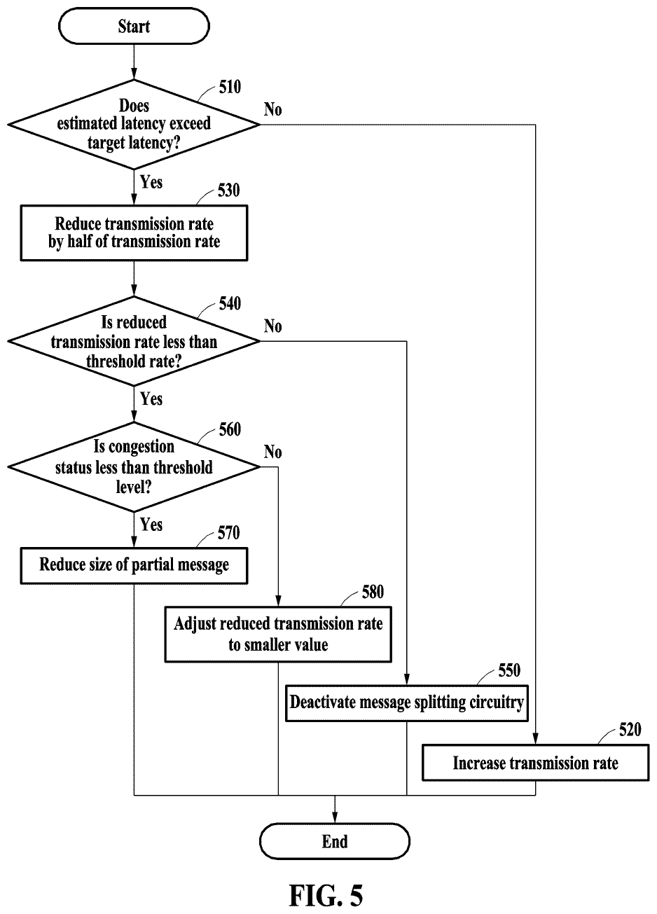

Examples of the operation of the message shaper module 154 will be described in more detail later with reference to FIGS. 4 and 5.

The switch 140 may include the switch 140 that manages the connection to a network. The switch 140 may transmit a message received through the NIC 130 in a direction corresponding to the destination by routing the message. The switch 140 may support the electronic device 100 to communicate smoothly with a plurality of network nodes. The switch 140 may include a plurality of ports. The ports may include an ingress port and an egress port. As described above, the switch 140 may further include the congestion status register 141 that stores the congestion status of the network.

In FIG. 1, hardware modules (e.g., hardware modules including the processing circuitry and hardware modules including elements of the memory 120) may be drawn in solid lines, and software modules (e.g., software modules including instructions) may be drawn in dotted lines.

FIG. 2 illustrates an example of a method transmitting at least a portion of a target message to a destination based on a message transmission request by an electronic device. Operations 210 to 240 of FIG. 2 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein.

According to an example, when a message transmission request is obtained, an NIC (e.g., the NIC 130 of FIG. 1) of an electronic device (e.g., the electronic device 100 of FIG. 1) may transmit a target message of the message transmission request to a destination.

In operation 210, the NIC may obtain a message transmission request for transmitting at least a portion of a target message to a destination based on one or more running applications (e.g., the application 152 of FIG. 1). The NIC may obtain the message transmission request independently of an OS (e.g., the OS 151 of FIG. 1).

According to an example, the message transmission request may be generated regarding a running application. When it is determined that a message is transmitted in the RDMA mode, the message transmission request may be inserted into a queue pair (QP) allocated to the application.

A QP may be a portion of a memory allocated to each application and may include a send queue (SQ) and a receive queue (RQ). A SQ may store, as element(s), message transmission request(s) generated regarding an application. A RQ may store, as element(s), message reception request(s) received based on an application. A message reception request may include a request to transmit (e.g., input) a message of a message transmission request based on another application running in an electronic device or a message received from another device to the application. The transmission of the message to the application may include applying it as an input of instructions of the application.

The processor may generate the message transmission request based on the application, and store the message transmission request in the QP (e.g., SQ of the QP) corresponding to the application when it is determined that a message of the generated message transmission request is to be transmitted in the RDMA mode. When an access request for the message transmission request based on the application is received from the NIC, the processor may transmit the message transmission request from the QP to the NIC. An operation of the processor transmitting the message transmission request to the NIC may be performed independently of the OS (e.g., without going through the OS).

The NIC may obtain (e.g., read) the target message indicated by the message transmission request based on the obtaining of the message transmission request.

In operation 220, the NIC may determine whether message split circuitry (e.g., the message split circuitry 131 of FIG. 1) of the NIC is activated. For example, the NIC may determine the message split circuitry is activated when a split register (e.g., the split register 132 of FIG. 1) of the NIC stores a first value indicating activation of the message split circuitry and may determine the message split circuitry is not activated (e.g., deactivated) when the split register stores a second value indicating deactivation of the message split circuitry.

When the NIC determines the message split circuitry is activated in operation 220, in operation 230, the NIC may split at least a portion of the target message into two or more packets using the message split circuitry, and transmit the two or more packets to a destination based on a value indicating activation of the message split circuitry being stored in the split register.

When the NIC determines the message split circuitry is not activated in operation 220, in operation 240, the NIC may transmit the at least a portion of the target message, as a single packet, to the destination based on a value indicating deactivation of the message split circuitry being stored in the split register.

As described above with reference to FIG. 1, when the message transmission request is divided into a plurality of partial message transmission requests by a software module (e.g., the division module 154-1 of FIG. 1), the NIC may receive the partial message transmission request as the message transmission request or instead of the message transmission request. As in or similar to operations 230 and 240, the NIC may split a partial message into two or more packets using the message split circuitry and transmit the two or more packets to the destination based on the value indicating activation of the message split circuitry being stored in the split register, or the NIC may transmit the partial message as a single packet to the destination based on the value indicating deactivation of the message split circuitry being stored in the split register.

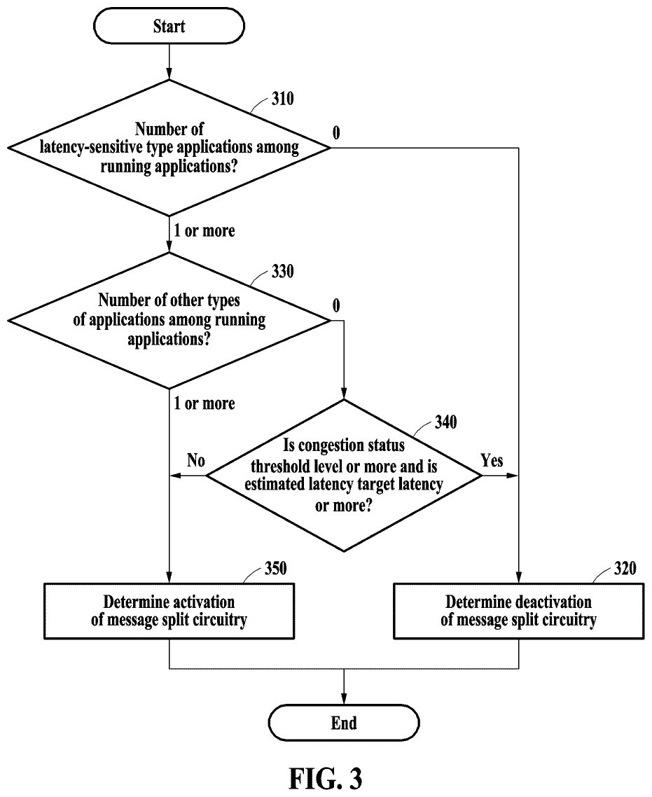

FIG. 3 illustrates an example of an operation of determining activation of message split circuitry by an electronic device. Operations 310 to 350 of FIG. 3 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein.

An electronic device according to an example (e.g., the electronic device 100 of FIG. 1) may determine whether to activate message split circuitry (e.g., the message split circuitry 131 of FIG. 1) using a directing module (e.g., the directing module 153-3 of FIG. 1). The electronic device may determine whether to activate the message split circuitry based on a type of a running application.

The type of application may be determined as one of a plurality of types including a latency-sensitive type. The type of application may be determined according to an attribute that has a greatest impact on the performance of the application among attributes of message transmission according to the message transmission request based on the application. For example, the attributes of the message transmission may include a latency, a bandwidth, and throughput. The plurality of types of applications may include a latency-sensitive type, a bandwidth-sensitive type, and a throughput-sensitive type. The latency-sensitive type may refer to an application where the latency of the message transmission has a significant impact on the performance of the application. The bandwidth-sensitive type may refer to an application where the bandwidth of the message transmission has a significant impact on the performance of the application. The throughput-sensitive type may refer to an application where the throughput has a significant impact on the performance of the application.

In various examples of the present disclosure, another type may refer to type(s) different from the latency-sensitive type. The other type may include at least one of the bandwidth-sensitive type and/or the throughput-sensitive type.

For the latency-sensitive type application, since lowering the latency may improve the performance of the application, the electronic device may process a message transmission request based on the latency-sensitive type application with priority (e.g., may prioritize the processing of the message transmission request based on the latency-sensitive type application with priority)_over a message transmission request based on the other type of application. Hereinafter, an example of a method of processing the message transmission request based on the latency-sensitive type application with priority when the electronic device is executing the latency-sensitive type application will be described.

In operation 310, the electronic device may confirm the number of latency-sensitive type applications among the running applications.

In operation 320, the electronic device may determine deactivation of (e.g., determine to deactivate) the message split circuitry based on the latency-sensitive type application not being present among the running applications (e.g., when the number of latency-sensitive type applications is determined to be zero in operation 310). In an example, when the electronic device determines the deactivation of the message split circuitry, the electronic device may store the second value indicating the deactivation of the message split circuitry in the split register.

When all the running applications are of different types (e.g., when none of the running applications are the latency-sensitive type), the NIC splitting a message into a plurality of packets and through the activation of the message split circuitry and transmitting the message may not have a significant impact on the performance of the applications (or the performance of the network). Therefore, electronic device of one or more embodiments may reduce the computational amount and power consumption by deactivating unnecessary (or inefficient) message split circuitry.

In operation 330, the electronic device may confirm the number of other types of applications among the running applications when the latency-sensitive type applications are present among the running applications (e.g., when the number of latency-sensitive type applications is determined to be one or more in operation 310).

In operation 340, the electronic device may determine whether to activate the message split circuitry based on the congestion status and the estimated latency, based on the latency-sensitive type application being present among the running applications and the other type of application not being present (e.g., when the number of the other types of applications is determined to be zero in operation 330). The electronic device may determine the congestion status based on a value stored in a congestion status register (e.g., the congestion status register 141 of FIG. 1). The electronic device may determine the estimated latency based on a latency monitoring module (e.g., the latency monitoring module 153-1 of FIG. 1).

For example, in operation 350, the electronic device may determine to activate the message split circuitry based on the congestion status being less than a threshold level or the estimated latency being target latency or less (e.g., when the congestion status is determined not to be greater than or equal to the threshold level or the estimated latency is determined not to be greater than or equal to the target latency in operation 340). In an example, when the electronic device determines to activate the message split circuitry, the electronic device may store the first value indicating the activation of the message split circuitry in the split register. The NIC of one or more embodiments may achieve an increased link utilization level and reduced latency by splitting a message into a plurality of packets and transmitting the plurality of packets when the message split circuitry is activated.

For example, in operation 320, the electronic device may determine to deactivate the message split circuitry based on the congestion status being the threshold level or more and the estimated latency exceeding the target latency (e.g., when the congestion status is determined to be greater than or equal to the threshold level and the estimated latency is determined to be greater than or equal to the target latency in operation 340). When the congestion status is the threshold level or more, the latency may increase as the plurality of packets split from the message are not transmitted in order. The electronic device of one or more embodiments may determine the deactivation of the message split circuitry based on the congestion status being the threshold level or more and the estimated latency exceeding the target latency, thereby preventing an increase in the latency.

In operation 350, the electronic device may determine the activation of the message split circuitry based on the latency-sensitive type application and the other type of application being present among the running applications (e.g., when the number of the other types of applications is determined to be one or more in operation 330). When the latency-sensitive type application and the other type of application are running simultaneously, the electronic device of one or more embodiments may improve the performance of both the latency-sensitive type application and the other type of application by splitting the message into a plurality of packets and transmitting the plurality of packets.

However, although not explicitly shown in FIG. 3, when the latency-sensitive type application and the other type of application are present among the applications run by the electronic device, it is not limited to activating the message split circuitry. When the latency-sensitive type application and the other type of application are present among the running applications, the electronic device may determine whether to activate the message split circuitry based on the estimated latency and the transmission rate.

In various examples of the present disclosure, the transmission rate may refer to a speed at which a message transmission request (or a partial message transmission request) related to another type of application is transmitted to an NIC. As described above, the transmission rate may represent a size (unit: bytes) of a message (or a partial message) of a message transmission request (or a partial message transmission request) transmitted per unit time. As will be described in an example later with reference to FIG. 4, a message transmission request generated regarding the latency-sensitive type application may be directly transmitted to the NIC, and a message transmission request generated regarding the other type of application may be transmitted to the NIC through an intermediate queue. As a result, a message transmission request transmitted at a transmission rate determined using a pacer module (e.g., the pacer module 154-2 of FIG. 1) may be the message transmission request generated regarding the other type of application.

For example, when the latency-sensitive type application and the other type of application are present among the running applications, the electronic device may determine the deactivation of the message split circuitry based on the estimated latency exceeding the target latency and the transmission rate for the other type of application being a threshold rate or more. When the latency-sensitive type application and the other type of application are present among the running applications, the electronic device may determine the activation of the message split circuitry based on the estimated latency being the target latency or less and the transmission rate for the other type of application being less than the threshold rate.

According to an example, when the estimated latency exceeds the target latency and the transmission rate is the threshold rate or more, it may not be substantially possible to reduce the latency of the message transmission based on the latency-sensitive type application by sacrificing the message transmission based on the other type of application. When the transmission rate is the threshold rate or more, the electronic device may deactivate the message split circuitry. The electronic device may transmit a message as a single packet according to the deactivation of the message split circuitry. The electronic device of one or more embodiments may reduce the latency of the message transmission based on the latency-sensitive type application by preventing a plurality of packets from occupying a link for the message transmission based on the other type of (e.g., bandwidth-sensitive type) applications. Also, the electronic device of one or more embodiments may reduce unnecessary computational amount and power consumption related to the message split circuitry of the NIC through the deactivation of the message split circuitry.

For example, the electronic device may determine to activate the message split circuitry based on the latency-sensitive types of application and the other type of application being present among the running applications. After that, the electronic device may switch (e.g., re-determine) from the activation to the deactivation of the message split circuitry based on the estimated latency exceeding the target latency and the transmission rate for the other type of application being the threshold rate or more.

FIG. 4 illustrates an example of an operation of transmitting a message transmission request to an NIC based on a type of an application by an electronic device.

An electronic device according to an example (e.g., the electronic device 100 of FIG. 1) may include a memory 420 (e.g., the memory 120 of FIG. 1), an NIC 430 (e.g., the NIC 130 of FIG. 1), and a switch 440 (e.g., the switch 140 of FIG. 1). The electronic device (or the memory 420 of the electronic device) may further include an intermediate queue 421. The electronic device may determine whether to transmit a message transmission request based on an application to the NIC 430 through the intermediate queue 421 based on the type of the application. The intermediate queue 421 may be implemented as a type of QP.

In operation 401, the electronic device may transmit (e.g., directly transmit) the message transmission request to the NIC 430 based on the message transmission request being generated regarding the latency-sensitive type application (e.g., an application A) among the running applications. The electronic device may transmit the message transmission request to the NIC 430 independently of the intermediate queue 421 (e.g., without going through or using the intermediate queue 421).

The electronic device may transmit the message transmission request to the NIC 430 through the intermediate queue 421 based on the message transmission request being generated regarding another type of application (e.g., an application B) different from the latency-sensitive type application among the running applications. For example, in operation 402, the electronic device may insert the message transmission request generated regarding the other type of application into the intermediate queue 421. In operation 403, the electronic device may transmit at least a portion of the message transmission request to the NIC 430 based on a result of determining to extract an element from the intermediate queue 421.

According to an example, the electronic device may determine to extract the element from the intermediate queue 421 based on a transmission rate for the other type of application. For example, the electronic device may determine a transmission rate and/or a size of a partial message. The electronic device may determine a time interval based on the transmission rate and the size of the partial message. The electronic device may determine the time interval using, for example, a message shaper control module (e.g., the message shaper control module 153 of FIG. 1). The electronic device may determine to extract the element from the intermediate queue 421 at determined time intervals (e.g., periodically). The electronic device may determine to extract the element from the intermediate queue 421 using a message shaper module (e.g., the message shaper module 154 of FIG. 1) and/or a pacer module (e.g., the pacer module 154-2 of FIG. 1). For example, the electronic device may determine a value obtained by dividing the size of the partial message by the transmission rate as the time interval.

An example of an operation in which the electronic device determines at least one of the transmission rate, the size of the partial message, and/or the time interval using the message shaper control module will be described in more detail later with reference to FIG. 5.

Although not explicitly shown in FIG. 4, the electronic device may split the message transmission request into a plurality of partial message transmission requests based on the size of the message (e.g., the target message) indicated by the message transmission request.

The electronic device may compare the size of the target message to a threshold message size based on the message transmission request being generated regarding the other type of application among the running applications.

For example, the electronic device may divide the message transmission request into partial message transmission requests and insert the partial message transmission requests, as a plurality of elements, into the intermediate queue 421 based on the size of the target message exceeding the threshold message size. The threshold message size may refer to a value set to a size of a partial message (or a maximum size of a partial message). An example of the determining of the size of the partial message will be described in more detail later with reference to FIG. 5. The partial message transmission requests may respectively correspond to a plurality of partial messages.

For reference, the electronic device dividing the message transmission request into the plurality of partial message transmission requests may refer to generating a message transmission request (e.g., a partial message transmission request) requesting transmission of a corresponding partial message to a destination with respect to each of the plurality of partial messages split from the message using a division module (e.g., the division module 154-1 of FIG. 1) of a message shaper module which is a software module. In various examples of the present disclosure, the NIC 430 splitting the message (or the partial message) into two or more packets using the message split circuitry, which is a hardware module, may be different from dividing the message transmission request into a plurality of partial message transmission requests.

For example, the plurality of partial messages may refer to parts of a message that are split from the target message. The electronic device may insert the message transmission request into the intermediate queue 421 based on a size of the target message being the threshold message size or less.

The NIC 430 may transmit the partial message indicated by the partial message transmission request as a single packet or two or more packets based on receiving the partial message transmission request through the intermediate queue 421. The NIC 430 may transmit the partial message as a single packet or two or more packets based on whether the message split circuitry is activated.

The NIC 430 may transmit the single packet or the two or more packets to the switch 440. The switch 440 may input each packet into an egress port. The packet transmitted through the egress port may be transmitted to another node (e.g., another electronic device) in the network.

FIG. 5 illustrates an example of an operation of determining a transmission rate by an electronic device. Operations 510 to 580 of FIG. 5 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein.

An electronic device according to an example (e.g., the electronic device 100 of FIG. 1) may determine a transmission rate for another type of application. For example, the electronic device may determine a transmission rate (e.g., perform some or all of operations 510 to 580) when both the latency-sensitive type application and the other type of application are present among the running applications.

In operation 510, the electronic device may compare the estimated latency with target latency. The target latency may refer to a preset latency target value for a message transmission request generated regarding the other type of application.

In operation 520, the electronic device may increase the transmission rate when the estimated latency is the target latency or less. For example, the electronic device may increase the transmission rate by a preset value (e.g., 1 byte per unit time). When the estimated latency is the target latency or less, since the goal of performance of the latency-sensitive type application (e.g., performance based on latency) is already satisfied, the electronic device of one or more embodiments may improve the performance of the other type of application by increasing the transmission rate for the other type of application.

In operation 530, when the estimated latency exceeds the target latency, the electronic device may reduce the transmission rate for the other type of application based on a half of the transmission rate. When the estimated latency exceeds the target latency, since the goal of performance of the latency-sensitive type application is not satisfied, the electronic device of one or more embodiments may improve the performance of the latency-sensitive type application by sacrificing the performance of the other type of application (e.g., reduce the transmission rate).

For example, the electronic device may reduce the transmission rate to a value that is not smaller, among the half of the transmission rate and a minimum rate. A minimum rate may refer to a preset minimum value of the transmission rate for the message transmission request generated regarding the other type of application. The electronic device may change the transmission rate to the half of the transmission rate based on the half of the transmission rate being the minimum rate or more. The electronic device may change the transmission rate to the minimum rate based on the half of the transmission rate being less than the minimum rate.

In operation 540, the electronic device may confirm whether the reduced transmission rate is less than a threshold rate when the estimated latency exceeds the target latency. A threshold rate may refer to a preset threshold value of the transmission rate for the message transmission request generated regarding the other type of application. The threshold rate may represent a transmission rate for determining whether the other type of application has sacrificed enough for the latency-sensitive type application.

In operation 550, the electronic device may determine to deactivate the message split circuitry based on the reduced transmission rate being less than the threshold rate. As described above in FIG. 3, when the estimated latency exceeds the target latency and the transmission rate is the threshold rate or more, it may not be substantially possible to reduce the latency of the message transmission based on the latency-sensitive type application by sacrificing the message transmission based on the other type of application. Therefore, when the estimated latency exceeds the target latency and the transmission rate is the threshold rate or more, the electronic device may determine to deactivate the message split circuitry. The electronic device may store a value indicating the deactivation of the message split circuitry in a split register.

In operation 560, the electronic device may compare a congestion status to a threshold level based on the reduced transmission rate being less than the threshold rate.

In operation 570, when the transmission rate is reduced (e.g., when the estimated latency exceeds the target latency), the electronic device may reduce the size of a partial message indicated by each partial message transmission request based on the reduced transmission rate being less than the threshold rate and the congestion status being less than the threshold level. The electronic device may reduce the size of the partial message by a preset value (e.g., 1 byte). As the size of the partial message is reduced, the latency of the message transmission based on the latency-sensitive type application may be reduced.

In operation 580, when the transmission rate is reduced (e.g., when the estimated latency exceeds the target latency), the electronic device may adjust the reduced transmission rate to a smaller value based on the reduced transmission rate being less than the threshold rate and the congestion status being the threshold level or more. For example, the electronic device may further reduce the transmission rate by a preset value (e.g., 1 byte per unit time). When the network is highly congested (e.g., the congestion status is the threshold level or more) and the message transmission based on the other type of application may be additionally sacrificed (e.g., the transmission rate is the minimum rate or more), the electronic device may reduce a frequency of transmission of the message transmission request (or the partial message transmission request) generated regarding the other type of application (e.g., may further reduce the transmission rate). By reducing the transmission rate, the electronic device of one or more embodiments may alleviate (e.g., reduce) the congestion status of the network to a lower level.

Although not explicitly shown in FIG. 5, the electronic device may determine a time interval based on the determined transmission rate and size of the partial message. The electronic device may determine to extract the element (e.g., the message transmission request or the partial message transmission request) from the intermediate queue at the determined time intervals.

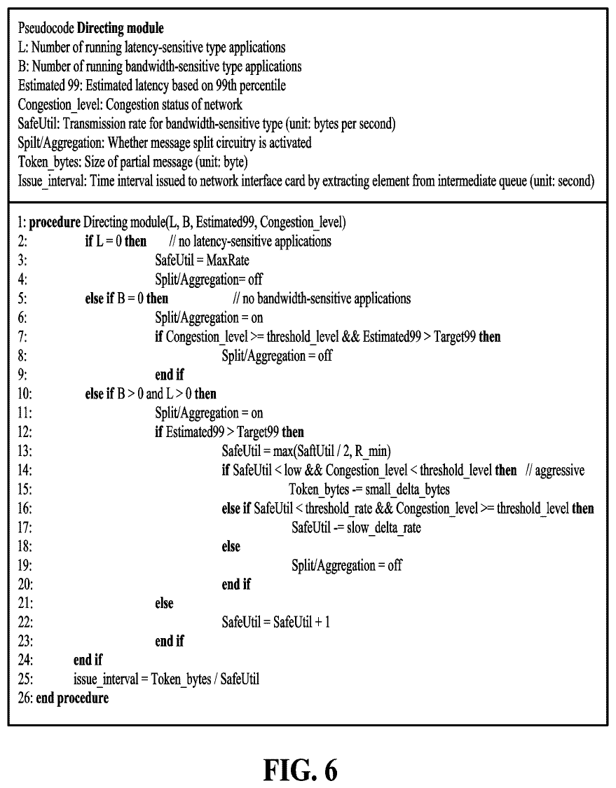

FIG. 6 illustrates an example of an operation of a directing module.

A directing module according to an example (e.g., the directing module 153-3 of FIG. 1) may operate based on a pseudo code illustrated in FIG. 6.

In FIG. 6, for convenience of description, the other type of application is described as the bandwidth-sensitive type application, but is not limited thereto, and other type of application may include a bandwidth-sensitive type application and/or a throughput-sensitive type application.

In Line 1, the directing module may obtain (e.g., receive) the number of running latency-sensitive type applications (L), the number of running bandwidth-sensitive type applications (B), estimated latency (Estimated99), and a congestion level (Congestion_level).

In Lines 2 to 4, the directing module may determine to set a transmission rate (SafeUtil) to a maximum rate (MaxRate) and determine deactivation (off) regarding whether to activate message split circuitry (Split/Aggregation) based on the number (L) of running latency-sensitive type applications being 0.

In Lines 5 and 6, the directing module may determine the activation (on) regarding whether to activate the message split circuitry (Split/Aggregation) based on the number of running latency-sensitive type applications (L) not being 0 and the number of running bandwidth-sensitive type applications (B) being 0. In Lines 7 to 9, when the number of running latency-sensitive type applications (L) is not 0 and the number of running bandwidth-sensitive type applications (B) is 0, if the congestion level (Congestion_level) is a threshold level (threshold_level) or more and the estimated latency (Estimated99) exceeds target latency (Target99), the directing module may determine deactivation (off) regarding whether to activate the message split circuitry (Split/Aggregation).

Lines 10 to 24 describe operations of the directing module when the number of running latency-sensitive type applications (L) exceeds 0 and the number of running bandwidth-sensitive type applications (B) exceeds 0.

In Line 11, the directing module may determine the activation (on) regarding whether to activate the message split circuitry (Split/Aggregation) based on the number of running latency-sensitive type applications (L) exceeding 0 and the number of running bandwidth-sensitive type applications (B) exceeding 0.

In Lines 12 to 20, when the estimated latency (Estimated99) exceeds the target latency (Target99), the directing module may determine at least one of the transmission rate (SafeUtil), a size of a partial message (Token_bytes), and/or whether to activate the message split circuitry (Split/Aggregation).

In Line 13, when the estimated latency (Estimated99) exceeds the target latency (Target99), the directing module may reduce the transmission rate (SafeUtil) to a value that is not smaller (max(SafeUtil/2, R_min)), among the half of the transmission rate (SafeUtil) and a minimum rate (R_min).

In Lines 14 to 15, when the reduced transmission rate (SafeUtil) is less than a threshold rate (threshold_rate) and the congestion level (Congestion_level) is less than the threshold level (threshold_level), the directing module may reduce the size of the partial message (Token_bytes) by a preset value (small_delta_bytes).

In Lines 16 to 17, when the reduced transmission rate (SafeUtil) is less than the threshold rate (threshold_rate) and the congestion level (Congestion_level) is the threshold level (threshold_level) or more, the directing module may further reduce the reduced transmission rate (SafeUtil) by the preset value (small_delta_rate).

In Lines 18 to 20, when the reduced transmission rate (SafeUtil) is the threshold rate (threshold_rate) or more, the directing module may determine deactivation (off) regarding whether to activate the message split circuitry (Split/Aggregation).

In Lines 21 to 20, when the estimated latency (Estimated99) is the target latency (Target99) or less, the directing module may increase the transmission rate (SafeUtil) by a preset value (e.g., 1 byte/sec).

In Line 25, the directing module may determine a time interval (issue_interval) as a value obtained by dividing the size of the partial message (Token_bytes) by the transmission rate (SafeUtil).

The examples described herein may be implemented using a hardware component, a software component and/or a combination thereof.

The electronic devices, processors, memories, NICs, switches, message split circuitries, split registers, congestion status registers, electronic device 100, processor 110, memory 120, NIC 130, switch 140, message split circuitry 131, split register 132, congestion status register 141, memory 420, NIC 430, and switch 440 described herein, including descriptions with respect to respect to FIGS. 1-6, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-6 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An electronic device comprising:
one or more processors configured to:
determine whether to activate a message split circuitry included in a network interface card (NIC) based on either one or both of information on one or more running applications and an estimated latency; and
store the determination of whether to activate the message split circuitry in a split register included in the NIC; and
the NIC configured to:
obtain a message transmission request for transmitting one or more portions of a target message to a destination based on the one or more running applications;
split, using the message split circuitry of the NIC, the one or more portions of the target message into two or more packets using the message split circuitry and transmit the two or more packets to the destination in response to a value indicating activation of the message split circuitry being stored in the split register; and
transmit the one or more portions of the target message, as a single packet, to the destination in response to a value indicating deactivation of the message split circuitry being stored in the split register.

2. The electronic device of claim 1, wherein
the NIC comprises a remote direct memory access (RDMA) NIC (RNIC) supporting an RDMA, and
the NIC is configured to receive the message transmission request independently of an operating system (OS).

3. The electronic device of claim 1, wherein the one or more processors are configured to determine deactivation of the message split circuitry in response to a latency-sensitive type application not being present among the one or more running applications.

4. The electronic device of claim 1, further comprising:
a switch comprising a congestion status register configured to store a congestion status of a network,
wherein the one or more processors are configured to determine whether to activate the message split circuitry based on the congestion status and the estimated latency, in response to a latency-sensitive type application being present and another type of application different from the latency-sensitive type application not being present among the one or more running applications.

5. The electronic device of claim 4, wherein the other type comprises either one or both of a bandwidth-sensitive type and a throughput-sensitive type.

6. The electronic device of claim 5, wherein the one or more processors are configured to:
determine the deactivation of the message split circuitry in response to the congestion status being greater than or equal to a threshold level and the estimated latency being greater than or equal to a target latency; and
determine the activation of the message split circuitry in response to either one or both of the congestion status being less than the threshold level and the estimated latency being less than the target latency.

7. The electronic device of claim 1, wherein the one or more processors are configured to determine the activation of the message split circuitry in response to a latency-sensitive type application and another type of application different from the latency-sensitive type application being present among the one or more running applications.

8. The electronic device of claim 1, wherein the one or more processors are configured to:
in response to a latency-sensitive type application and another type of application being present among the one or more running applications, determine the deactivation of the message split circuitry in response to the estimated latency being greater than or equal to a target latency and a transmission rate for the other type of application being greater than or equal to a threshold rate; and
in response to the latency-sensitive type application and the other type of application being present among the one or more running applications, determine the activation of the message split circuitry in response to the estimated latency being less than the target latency and the transmission rate for the other type of application being less than the threshold rate.

9. The electronic device of claim 1, wherein the one or more processors are configured to determine the estimated latency by transmitting a probing message to a destination of one or more message transmission requests from the one or more running applications.

10. The electronic device of claim 9, wherein the one or more processors are configured to determine the estimated latency by periodically transmitting the probing message with a size less than or equal to a threshold message size to the destination.

11. The electronic device of claim 1, further comprising:
a memory comprising an intermediate queue,
wherein the one or more processors are configured to:
transmit the message transmission request to the NIC in response to the message transmission request being generated based on a latency-sensitive type application among the one or more running applications;
insert the message transmission request to the intermediate queue in response to the message transmission request being generated based on another type of application different from the latency-sensitive type application among the one or more running applications; and
transmit one or more portions of the message transmission request inserted to the intermediate queue to the NIC in response to determining to extract an element from the intermediate queue.

12. The electronic device of claim 11, wherein
the one or more processors are configured to:
compare a size of the target message with a threshold message size in response to the message transmission request being generated regarding the other type of application among the one or more running applications;
divide the message transmission request into partial message transmission requests and insert the partial message transmission requests, as a plurality of elements, into the intermediate queue in response to the size of the target message being greater than or equal to the threshold message size; and
insert the message transmission request to the intermediate queue in response to the size of the target message being less than or equal to the threshold message size, and
the NIC is configured to transmit a partial message indicated by the partial message transmission request as either one of a single packet or two or more packets in response to the partial message transmission request being received through the intermediate queue.

13. The electronic device of claim 11, wherein the one or more processors are configured to determine to extract the element from the intermediate queue based on a transmission rate for the other type of application.

14. The electronic device of claim 13, wherein the one or more processors are configured to:
in response to the estimated latency being greater than or equal to a target latency, reduce the transmission rate for the other type of application based on a half of the transmission rate; and
in response to the estimated latency being less than the target latency, increase the transmission rate.

15. The electronic device of claim 14, further comprising:
a congestion status register configured to store a congestion status of a network,
wherein the one or more processors are configured to, in response to the transmission rate being reduced, reduce a size of a partial message indicated by each partial message transmission request in response to the reduced transmission rate being less than a threshold rate and the congestion status being less than a threshold level.

16. The electronic device of claim 15, wherein the one or more processors are configured to, in response to the transmission rate being reduced, adjust the reduced transmission rate to a smaller value in response to the reduced transmission rate being less than the threshold rate and the congestion status being the threshold level or more.

17. The electronic device of claim 13, wherein the one or more processors are configured to:
determine a time interval based on the transmission rate and a size of a partial message; and
determine to extract the element from the intermediate queue at the determined time interval.

18. A method comprising:
determining, by one or more processors, whether to activate a message split circuitry included in a network interface card (NIC) based on either one or both of information on one or more running applications and an estimated latency;
storing, by the one or more processors, the determination of whether to activate the message split circuitry in a split register included in the NIC;
obtaining, by the NIC, a message transmission request for transmitting one or more portions of a target message to a destination based on the one or more running applications;
splitting, by the message split circuitry of the NIC, the one or more portions of the target message into two or more packets using the message split circuitry and transmitting the two or more packets to the destination in response to a value indicating activation of the message split circuitry being stored in the split register; and
transmitting, by the NIC, the one or more portions of the target message, as a single packet, to the destination in response to a value indicating deactivation of the message split circuitry being stored in the split register.

19. The method of claim 18, wherein
the NIC comprises a remote direct memory access (RDMA) NIC (RNIC) supporting an RDMA, and
the NIC is configured to receive the message transmission request independently of an operating system (OS).

20. A non-transitory computer-readable storage medium storing code that, when executed by the one or more processors, configures the one or more processors to perform the determining of whether to activate the message split circuitry, and the storing of the determination of whether to activate the message split circuitry in the split register.
